(19) United States
(12) Patent Application Publication
(10) Pub. No.: US 2015/0359609 A1
(43) Pub. Date: Dec. 17, 2015

(54) METHOD FOR PRODUCING AN ORTHODONTIC SETUP

(71) Applicant: ORTHO CAPS GMBH, Hamm (DE)

(72) Inventor: Wajeeh Khan, Hamm (DE)

(21) Appl. No.: 14/745,198

(22) Filed: Jun. 19, 2015

Related U.S. Application Data
(63) Continuation of application No. PCT/EP2013/077647, filed on Dec. 20, 2013.

(30) Foreign Application Priority Data
Dec. 21, 2012 (DE) 10 2012 113 025.6
Sep. 13, 2013 (GB) 1316297.9

(51) Int. Cl. A61C 7/00; A61C 9/00; B29C 51/00; A61C 7/08

(52) U.S. Cl. CPC A61C 7/002; A61C 7/08; A61C 9/0006; A61C 9/0053; B29C 51/00; B29L 2031/753

(57) ABSTRACT

The present invention relates to methods for producing an orthodontic setup, comprising a) producing at least one physical alveolar ridge model, said alveolar ridge model having cavities for receiving tooth models, b) producing tooth models, and c) optionally: placing the tooth models in said alveolar ridge model.

### CROSS-REFERENCE TO RELATED APPLICATIONS

The present application claims priority from and is a continuation from PCT Application No. PCT/EP2013/077647, filed Dec. 20, 2013, which claims priority from German Application No. 10 2012 113 025.6, filed Dec. 21, 2012 and Great Britain Application No. 1316297.9, filed Sep. 13, 2013, all herein incorporated by reference in their entireties.

### BACKGROUND OF THE INVENTION

Aligners are orthodontic devices that are individually adapted to the patient and are usually made of a transparent plastic and used as an alternative to traditional metal braces for aligning and straightening the teeth. Like braces, they help to correct the positions of a person's teeth in relation to his or her bite and, in so doing, help to rectify orthodontic malpositioning, for example malocclusion.

Conventional methods for producing aligners are based on thermoforming suitable films over what is called an orthodontic setup. The latter generally consists of a plaster model, or of a model which is produced by means of 3D printing and which represents the actual state, the desired state or a transitional state of the entire upper or lower jaw composed of alveolar ridge and teeth.

This conventional method is associated with a great many disadvantages. Thus, it generally only permits the production of aligners of inferior optical quality. Moreover, it uses up a very large amount of material and is additionally time-consuming.

It is therefore an object of the present invention to make available methods and devices that eliminate the stated disadvantages.

It is a further object of the present invention to make available methods and devices that permit the production of aligners of high optical quality.

It is a further object of the present invention to make available methods and devices that allow aligners to be produced cost-effectively and/or in a way that saves resources.

It is a further object of the present invention to make available methods and devices permitting the production of aligners that pose a low risk of irritation or damage to the gums.

These objects are achieved by the methods and devices according to the independent claims of the present invention. The dependent claims describe preferred embodiments. Value ranges that are limited by numerical values are always intended to include said limit values.

### SUMMARY OF THE INVENTION

Before the invention is described in detail, it will be noted that this invention is not limited to defined component parts of the described devices, or described production steps of the methods, since these methods and devices may vary. It will also be noted that the terminology for this is used only for the purpose of defined described embodiments and is not intentionally limited.

It will be noted that in the description used, and in the attached claims, the simple form such as “a” or “the” includes a singular and/or plural subject, except when it is clearly worded otherwise in the context. It is also agreed that, where a parameter range has been indicated, the limiting numerical values are regarded as limit values for the numerical range.

The term “aligner” as used here is synonymous with the terms “retainer”, “positioner” and “splint”. Although a distinction is sometimes made in the literature between aligners and retainers, so that aligners are intended to bring about an active change of the tooth position while retainers are intended merely to fix or establish a change of tooth position that has been brought about in another way, this distinction is not applied consistently in the literature. Ultimately, it makes no difference whether a plastic splint introduces forces into a tooth in order to actively change its position or only to fix its position.

According to the invention, a method for producing an orthodontic setup is proposed which comprises:

a) producing at least one physical alveolar ridge model, said alveolar ridge model having cavities for receiving tooth models;
b) producing tooth models; and
c) optionally: placing the tooth models in said alveolar ridge model.

According to the invention, moreover, the alveolar ridge model (11) has at least one continuous recess. Preferably, the alveolar ridge model (11) has a multiplicity of continuous recesses (15).

These recesses (15) can be introduced as a mainly slit-shaped or oblong-hole-shaped recess (15), preferably below a cavity (12). In a preferred embodiment of the invention, the alveolar ridge model has at least one continuous recess or a multiplicity of continuous recesses, i.e. 2, 3, 4, 5, 6, 7, 8, 9, 10, 11, 12, 13, 14, 15, 16, 17, 18, 19 or 20 or more. The number and the diameter of the recesses are not limited to a defined number or size, as long as the air exchange from the top face to the underside of the alveolar ridge model is ensured. However, the recess preferably has a diameter of 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9 or 4.0 mm or more.

According to the invention, the alveolar ridge is produced from a durable, non-porous plastics material. This has the advantage that the physical alveolar ridge model is resistant and re-usable. Thus, without a renewed impression having to be taken manually or digitally from the patient, the same aligner for example can be produced on the alveolar ridge model according to the invention. This affords a great advantage over the customary methods of the prior art, in which plaster cast models are used for this purpose and are often damaged by the thermoforming and are thus no longer usable.

However, on account of the lack of porosity of the plastics material, the air cannot escape through the plastic during the thermoforming, as a result of which the film cannot conform with an exact fit to the physical tooth and/or the alveolar ridge model, or air inclusions occur. The inventor of the present invention has surprisingly discovered that, by introducing slit-shaped and/or oblong-hole-shaped, continuous recesses into the physical alveolar ridge model, an aligner can be produced by means of conventional printing and/or vacuum thermoforming methods and encloses the tooth models and the alveolar ridge model with an exact fit. Preferably, the recesses are applied on the alveolar ridge model and preferably form a continuation of the cavities, such that the air exchange is ensured. The recesses can also be applied laterally. In the simplest embodiment, the recesses are introduced into the model by subsequent drilling. Likewise, the recesses can already be calculated on the digital setup model and applied.

According to the invention, said alveolar ridge model is a positive model of an upper and/or lower jaw with gingiva, and it additionally has cavities corresponding more or less to the tooth sockets.

The term “orthodontic setup” designates a physical model of an upper and/or lower jaw that has the teeth and also the alveolar ridge. The setup can represent the actual state of a patient and also an initial, transitional or final correction state of a planned or performed orthodontic treatment.

Orthodontic setups are needed for the production of aligners, for example, but they can also be used for the production or modeling of conventional braces or brackets, or for diagnosis, for example for checking the feasibility/performability of a treatment.

Compared to the “perforated plate” (“dental base”) known from EP1876990 or US 2006/0127859, in which tooth models can be fitted in order thereafter to produce an aligner on this model by thermoforming, the method according to the invention has the advantage that the transition between the gingiva and the neck of the tooth is modeled true to nature by the interplay of a realistic alveolar ridge model and the tooth models. The aligners produced on such a setup therefore have anatomically shaped margins and, as a result, pose less danger of irritation or injury, particularly to the gingiva, than in the perforated plates mentioned. In addition, the gingiva does not then still have to be modeled in wax, which would have the effect that one would have to duplicate said wax model (form a negative) and then cast it in plaster, in order subsequently to have a model for the thermoforming method. Therefore, in a preferred embodiment of the present invention, the physical alveolar ridge model is designed as a positive model of an upper and/or lower jaw with gingiva.

Preferably, provision is also made that the tooth models

a) are labeled numerically, alphabetically or with the aid of a computer-readable code, and/or
b) have a physical orientation marker, for example in the form of a groove or a spring (with in each case a corresponding orientation marker in the cavities of the alveolar ridge)
in order to ensure a reproducible arrangement in the alveolar ridge model or in the different alveolar ridge models.

Provision is preferably made that the tooth models not only have a crown but also a neck and, possibly of simplified design, a root.

In the simplest case, the root can be designed as a simple pin, cylinder or truncated cone. In the most complicated case, the shape of the root corresponds exactly to the natural root of the corresponding tooth.

Moreover, the root is preferably designed in such a way that it does not end flush with the underside of the alveolar ridge model.

In the simplest case mentioned above, the simplified roots produced in this way serve merely to establish the orientation of the tooth models on the basis of a given cavity, to visualize this in a CAD model and to predict the orientation of the tooth models with corresponding manipulation of the associated cavity in the CAD model.

However, as the level of simplification decreases, the root models also permit a prediction of the feasibility of any kind of corrective therapy, since different correction states can be simulated in a CAD model, and their effects on the roots can be tested. For example, it is thus possible, in a planned correction state, to avoid a situation where the roots of adjacent teeth abut each other, or a root comes into contact with the jaw bone in the associated socket.

Provision is preferably also made that at least one cavity in said alveolar ridge model is designed, in terms of its shape and/or orientation, such that it determines the orientation of the associated tooth model in all six degrees of freedom.

According to this embodiment, provision is thus made that the shape of the cavity interacts with the shape of the root of the associated tooth model in such a way that it determines the orientation thereof. For this purpose, provision is made that the cavity and the root of the associated tooth model are at least in part connected to each other with a form fit.

Manipulation of the shape or orientation of the cavity thus automatically determines the orientation of the associated tooth model. In this way, a therapist is provided with a tool for determining the orientation of several tooth models in an orthodontic setup and, therefore, for producing an aligner that can perform a predetermined correction of the tooth position.

Degree of freedom designates the number of freely selectable, mutually independent movement possibilities of a system. A rigid body in space accordingly has the degree of freedom, since the body can be moved in three mutually independent directions and rotated in three mutually independent planes. In this meaning as the total number of the independent movement possibilities, the term degree of freedom occurs only in the singular. The individual movement possibilities are then also called freedoms. However, in the literature, and in general linguistic usage, each of the independent movement possibilities of a system is also designated as a degree of freedom. Accordingly, a rigid body without bindings has six degrees of freedom.

Provision is preferably also made that the method comprises the production of several alveolar ridge models, which differ from one another at least in terms of the shape and/or orientation of a cavity.

In this way, after the positive models have been fitted with the tooth models, it is possible to produce two or more aligners that can be used for an incremental corrective therapy of the tooth position.

In contrast to conventional methods in which, for the production of several aligners, the corresponding number of complete setups has to be produced, it is now necessary, according to the invention, to produce the corresponding number of alveolar ridge models, since these can each be fitted with the same tooth models. In this way, less material is used up, thereby saving time, reducing costs and preserving resources, and also avoiding unnecessary waste.

Particularly preferably, provision is also made that the method comprises the production a) of an alveolar ridge model which corresponds to the orthodontic actual state or an orthodontic initial correction state;

b) optionally of one or more alveolar ridge models which correspond to one or more orthodontic transitional correction states; and/or
c) of an alveolar ridge model which corresponds to an orthodontic final correction state.

The correspondence between the respective alveolar ridge model and the associated orthodontic actual state or correction state is achieved through the shape and/or orientation of the respective cavities which, as has been described, determines the orientation of the associated tooth models in all six degrees of freedom.

The term “final correction state” can designate the final state to be achieved in the context of a given therapy plan, which therapy plan can be followed by further therapy plans (which makes said final correction state a kind of provisional final state), or it can designate the clinically or esthetically desirable definitive final correction state.

Provision is preferably also made that an alveolar ridge model is produced by

a1) preparing a 3D scan of a cast, which cast is obtained by taking an impression of the upper or lower jaw of a patient with a suitable material, or an intraoral scan of the upper and/or lower jaw of a patient;
a2) optionally separating at least one part of the cast, and once again preparing a 3D scan of the at least one part of the cast;
b) preparing a virtual CAD model of the actual state of the upper or lower jaw of the patient,
wherein, optionally, the data of the 3D scans from steps a1 and a2 are processed to give a virtual CAD model of the actual state of the upper or lower jaw of the patient; and
   c) virtual removal of the teeth represented in the virtual CAD model of the actual state, along with the associated and possibly simplified roots, wherein cavities corresponding to the removed roots are generated in the first alveolar ridge CAD model thus obtained; and
   d) producing a physical alveolar ridge model (11) on the basis of said first alveolar ridge CAD model by means of a CAM technique.

Moreover, in step c), the method comprises a step of introducing at least one continuous recess (15) into the first alveolar ridge CAD model. According to the invention, this step can also be introduced later, i.e. in a modified alveolar ridge CAD model of an orthodontic initial, transitional or final correction state. Likewise, these recesses can also be introduced subsequently into the associated physical alveolar ridge models.

Preferably contactless methods can be used for the 3D scan, for example an optical strip light scanner, a laser scanner, a Flash CT scanner or an X-ray scanner.

In step 1a), as an alternative to scanning the cast, it is also possible not to produce a cast and instead to perform an intraoral scan by means of digital impression systems in the mouth of the patient. In this connection, an intraoral three-dimensional camera is used inter alia that is able to characterize or image a tooth, a group of teeth or a complete jaw using an optical system introduced into the mouth of a patient.

The intraoral scanning technique is known to a person skilled in the art, and relevant devices and software are commercially available, for example, from Straumann and Cadent Inc. These digital impression systems permit direct integration of rapid, precise and comfortable scanning on the treatment chair, and the integration of these generated data into the digital work sequence of the system according to the invention.

Contact-based measuring methods can likewise be used, for example probe-based measuring methods such as those marketed by the company Faro.

To obtain impressions, the impression-taking materials currently used in dentistry can preferably be used, for example materials based on silicone, hydrocolloid, polyether or alginate.

For the casting, it is likewise preferable to use the casting materials used in dentistry, for example plaster-based materials.

Step a2 is directed in particular to dentition situations in which the positions of a patient's teeth are unfavorable, for example as a result of crowding or twisting, and, consequently, it is not possible to scan the entire surface profile of one or more teeth. For this purpose, the casting can be separated by means of customary mechanical or manual methods into segments comprising a tooth and the base part of the cast, the cast parts thus separated, i.e. the at least one part from the cast, are scanned again. Thereafter, the digital information of the scans from steps a1 and a2 is digitally processed. This ensures that, even in the case of extensive malpositioning of the teeth, all the information concerning the physical cast model are also present in digital form, so as to be able to produce high-quality aligners.

In the simplest case, there is no patient-specific information regarding the shape and orientation of the roots in question. It is therefore possible to work with dummy models which are stored in the relevant software and have shapes and orientations representative of specific teeth. It is also possible to work with greatly simplified models of the roots, for example simple pins, cylinders or truncated cones.

In the present connection, the expression CAM relates to what is called computer aided manufacturing, in which a computer controls a production machine. CAM methods comprise what is called rapid prototyping, such as 3D plotting, 3D photolithography or CNC milling. CAM techniques are generally combined with CAD techniques (so-called CAD/CAM).

Moreover, provision is preferably made that at least one alveolar ridge model of an orthodontic initial, transitional or final correction state is produced by

a1) virtual manipulation of the orientation of at least one tooth in the virtual CAD model of the actual state, or in a modified CAD model of an initial or transitional correction state, in such a way that, after the virtual removal of the teeth represented in the virtual CAD model, the orientation of the associated cavity is altered in the modified alveolar ridge CAD model thereby obtained; or
a2) virtual manipulation of the shape and/or orientation of at least one cavity in the first alveolar ridge CAD model, or in a modified alveolar ridge CAD model of an initial or transitional correction state, in such a way that, as a result of the manipulation of the cavity in the modified alveolar ridge CAD model thus obtained, the orientation of the associated tooth is altered; and
b) production of a physical modified alveolar ridge model on the basis of said modified alveolar ridge CAD model by means of a CAM technique.

Once again, the correspondence between the respective alveolar ridge model and the associated orthodontic actual state or correction state is obtained through the shape and/or orientation of the respective cavities which, as has been mentioned, determines the orientation of the associated tooth models in all six degrees of freedom.

The manipulation of the orientation of at least one tooth in the virtual CAD model or the manipulation of the shape and/or orientation of at least one cavity in the alveolar ridge CAD model is effected in such a way that an orthodontic treatment plan is formulated that has the aim of providing a clinically and esthetically desirable positioning of the teeth.

In this context, for example, a clinically or esthetically desirable orthodontic final correction state can be defined for each tooth whose position is to be corrected, and the change of position required for this purpose can be quantified. Said change of position is then divided into subsidiary segments, on the basis of which the orthopedic initial and transitional correction states can then be defined.

Preferably, in addition to the virtual CAD model of the actual state of the upper or lower jaw of the patient,

a) a CAD model of at least one root is generated by means of an imaging method; and
b) said CAD model is added to the virtual CAD model of the actual state of the upper or lower jaw of the patient.

For this purpose, imaging X-ray methods such as DVT (digital volume tomography) or imaging 3D ultrasound methods are possible.

The two CAD models can be combined by means of suitable software, for example the Geomagic software.

In this way, information concerning the shape and orientation of the roots is obtained, which information can be included in the subsequent steps. In the simplest case, as has already been mentioned, the roots can be designed in the further methods as a simple truncated cone. In the most complicated case, the shape of root corresponds exactly to the natural root of the corresponding tooth.

Particularly preferably, the step of virtual removal of the teeth represented in the virtual CAD model is followed by a step of generating, revising and storing at least one tooth CAD model of a tooth removed in this way and of the associated and possibly simplified root.

Moreover, provision is preferably made that the method further comprises the step of producing at least one physical model of a tooth, and of a possibly simplified root, on the basis of said tooth CAD model by means of a CAM technique.

Provision is preferably made that the CAM technique used for producing the physical model of a tooth, and of a possibly simplified root, has a higher resolution than the CAM technique used for producing the physical alveolar ridge models.

The resolution of CAM techniques is defined, as in normal printing, in dpi (dots per inch) in the XYZ direction. The higher the dpi number, the higher the resulting resolution. In stereolithography methods and in 3D printing, the layer height can be increased in order to accelerate the process, which lowers the resolution in the Z direction. In CNC milling, the resolution depends on the mechanism of the milling machine and on the shape of the milling tool.

CNC methods tend to have a higher resolution than stereolithography methods, which in turn tend to have a higher resolution than 3D printing. In 2011, for example, 3D printing systems with a resolution of 600 dpi were regarded as high resolution. The resolution of the conventional CAM techniques increases continuously as the technology progresses, such that the subject matter of the invention is not in any way limited to the stated resolution values. Rather, it concerns a relative classification of the term “high resolution”.

Consequently, provision is preferably made that high-resolution CNC methods, high-resolution stereolithography methods or high-resolution 3D printing methods are used for producing the physical model of a tooth and of a possible simplified root. The advantage of this approach is that smoother surfaces can be generated on the associated tooth models, which in turn results in aligners of high optical quality, which are then produced by thermoforming on the associated orthodontic setup. On account of the fact that the tooth models used have a smoother surface, the aligners thus produced have less roughness and are therefore superior to conventionally produced aligners in terms of their transparency.

In a preferred embodiment, at least the crown (14a) of the tooth model (13) is less rough than the alveolar ridge model (11). In another preferred embodiment, the alveolar ridge model (11) is more rough than the tooth models, at least the crown.

The roughness of a surface (surface roughness) can be determined by customary methods. For example, suitable measuring devices include the surface-measuring device Perthometer S3P (Feinprüf Perthen GmbH, Gottingen, Germany) or suitable methods include confocal microscopy, conoscopic holography, focus variation or white light interferometry.

It is important here that high-resolution CAM techniques are much more time-consuming than low-resolution CAM techniques. Therefore, in order to produce a series of incremental orthodontic setups in the context of a position correction plan, it is uneconomical to produce these setups continuously with high-resolution CAM techniques.

The materials used for producing the tooth models are preferably metals, in particular titanium and stainless steel, but also ceramic materials. However, customary thermostable plastics can also be used. Suitable materials for the production of the alveolar ridge models are in particular 3D printing materials, and materials suitable for stereolithography.

In principle, however, it will be noted the materials for producing the tooth models are basically those materials with which, depending on the respective methods used, it is possible to generate relatively high-resolution models, whereas the materials used for producing the alveolar ridge models are basically those materials with which, depending on the respective methods used, it is possible to generate relatively low-resolution models.

In other words, or alternatively, it is advantageous if the material of the alveolar ridge model has less strength, hardness and/or density than the material of the tooth model. It is considered advantageous if the hardness, strength and/or density of the material of the alveolar ridge model is at least 10, 11, 12, 13, 14, 15, 16, 17, 18, 19, 20, 21, 22, 23, 24, 25, 26, 27, 28, 29, 30, 31, 32, 33, 34, 35, 36, 37, 38, 39 and/or 40% less than the strength, hardness and/or density of the material of the tooth part.

The alveolar ridge model, on the one hand, and the tooth models, on the other hand, can additionally have a different color and/or can be made from different materials. Thus, for example, the material of the alveolar ridge model can have a polyurethane material with a density of 500 kg/m³ and the material of the tooth models can have a polyurethane material with a density of 1200 kg/m³. The different choice of material leads to considerably greater wear resistance of the tooth models compared to the alveolar ridge model. Therefore, on account of the lower density and also the lower hardness and strength of the material of the alveolar ridge model, it is possible to mill said alveolar ridge model more easily and, above all, more quickly.

The approach according to the invention, in which

a series of alveolar ridge models, with at least partly differently oriented cavities, is produced using low-resolution CAM techniques, which results in a correspondingly rough surface of the different alveolar ridge models,

only the tooth models to be placed in the alveolar ridge model are produced using a high-resolution CAD technique,

the corresponding setups are then produced by successively placing the tooth models in the individual alveolar ridge models, and

the different incremental aligners are thus produced,

therefore combines the advantage of the high-resolution CAM technique for the production of the tooth models with the more economical low-resolution CAM technique for the production of the alveolar ridge models, thereby permitting economic production of aligners of high optical quality.

In a preferred embodiment of the invention, the cavities (12) of the alveolar ridge model enclose the shortened root (14) of the tooth models (13) with an exact fit.

According to the invention, the movement of the teeth and of the roots is calculated during an orthodontic treatment. This information is included in the setups and alveolar ridge models according to the invention and, consequently, in the aligners according to the invention, since the tooth models according to the invention have at least one shortened root, and the alveolar ridge model has cavities which enclose these necks and/or roots with an exact fit. Therefore, during the treatment with the aligners according to the invention, it is possible to avoid complications that could arise as a result of an altered position of the teeth and gradually of the roots.

Moreover, provision is preferably made that

a1) the virtual manipulation of the orientation of at least one tooth in the virtual CAD model of the actual state and/or in the virtual CAD model of an orthodontic initial, transitional or final correction state; or
a2) the virtual manipulation of the orientation of at least one cavity in the first alveolar ridge CAD model and/or the alveolar ridge CAD model of an orthodontic initial, transitional or final correction state
is performed on screen by an operator or by a predefined algorithm.

Particularly preferably, provision is made that at least one alveolar ridge model is produced from a transparent material. For this purpose, for example, it is possible to use transparent polymers such as polymethyl methacrylate (PMMA). Many suppliers of 3D printers, for example ObjetGeometries, or 3D Systems (Polyjet), offer transparent print materials for their printers.

Provision is preferably made that the alveolar ridge models, which correspond to the orthodontic actual state, the orthodontic initial correction state and/or the orthodontic final correction state are produced from the transparent material.

In this way, it is possible for a therapist and also for a patient to track not only the correction of the tooth position but also the effect of the corrective therapy on the positions of the roots.

Moreover, according to the invention, an orthodontic setup, or a kit comprising several orthodontic setups, is produced by a method according to the above description.

Likewise, according to the invention, a method for producing at least one orthodontic aligner is provided, wherein said aligner is produced by thermoforming a suitable material on an orthodontic setup according to the above description.

For this purpose, for example, transparent films with material thicknesses of between 0.3 and 1.5 mm are used (so-called thermoforming films), for example of polycarbonate (hard elastic), ethylene-vinyl acetate copolymer (soft elastic). Moreover, a laminated film composed of a hard-elastic layer and of a soft-elastic layer can be provided. Particularly preferable, however, are material films with a material thickness of between 0.3 and 5 mm.

With the aid of a thermoforming device, for example from the company Biostar, or the company Erkodent, the thermoforming film is then drawn over the orthodontic setup in order in this way to produce an aligner. The setup can be sprayed beforehand with a release agent.

In a preferred embodiment, the produced aligner (17) in the area of the alveolar ridge model (18) has a greater roughness than the part of the aligner formed over the crowns (19).

Thermoforming methods for producing positioners and aligners on orthodontic setups are already known to persons skilled in the art from Ponitz (1971) “Invisible Retainers”, Am J Orthod 59: 266, from McNamara (1993), “Orthodontic and Orthopedic Treatment in the Mixed Dentition”, NeedhamPr, and from a large number of other publications.

Further devices that can be produced by the method according to the invention comprise, for example, lingual and vestibular brackets, Herbst appliances, transpalatal arches, quad helices, Nance holding arches, positioners, functional removable appliances (activator, bionator, etc.), Crozat appliances, retainers, templates for indirect bonding, mouthguards, anti-snoring appliances, etc.

In addition, according to the invention, an aligner or set of aligners is produced by a method according to the above description.

### FIGURES

FIG. 1 shows an orthodontic setup 10 according to the present invention. The setup comprises an alveolar ridge model 11, which has cavities 12 for receiving tooth models 13, and also tooth models 13 which can be placed in said alveolar ridge model 11.

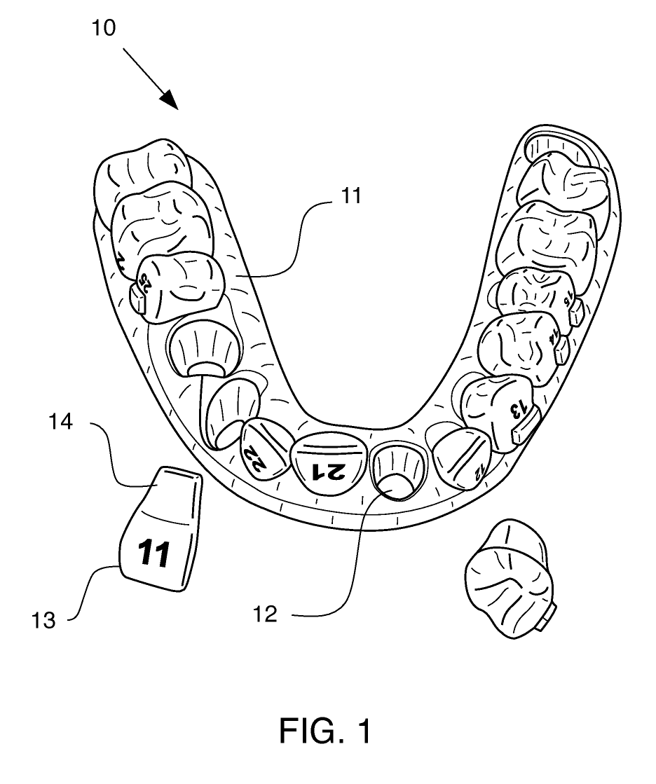

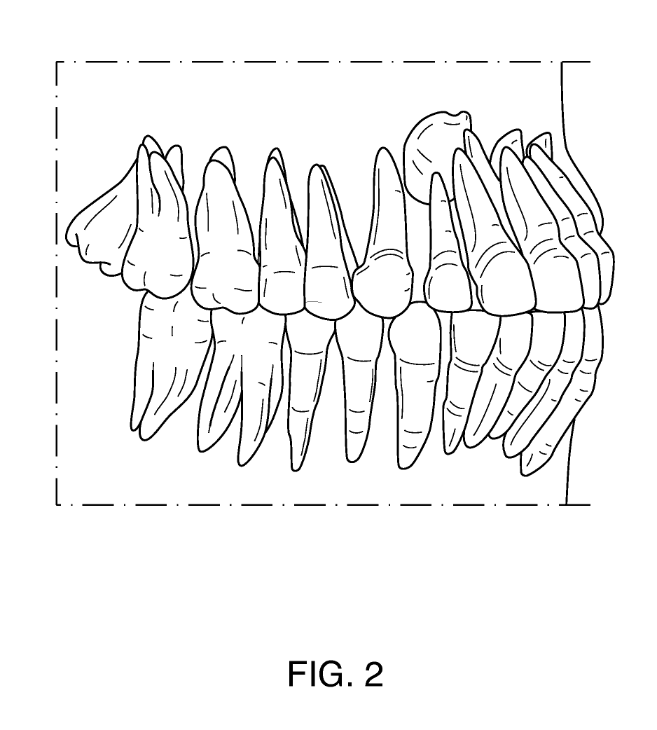

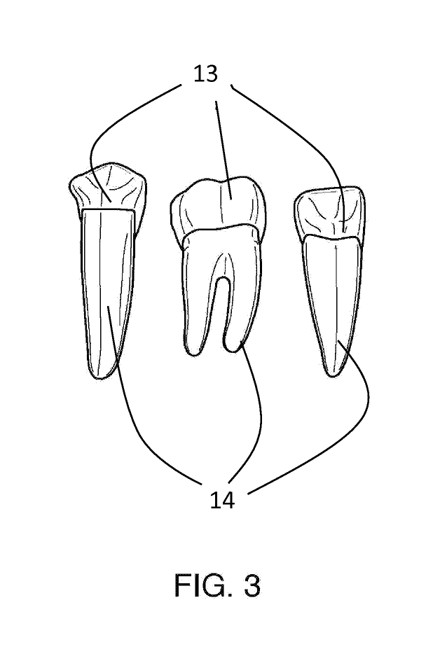

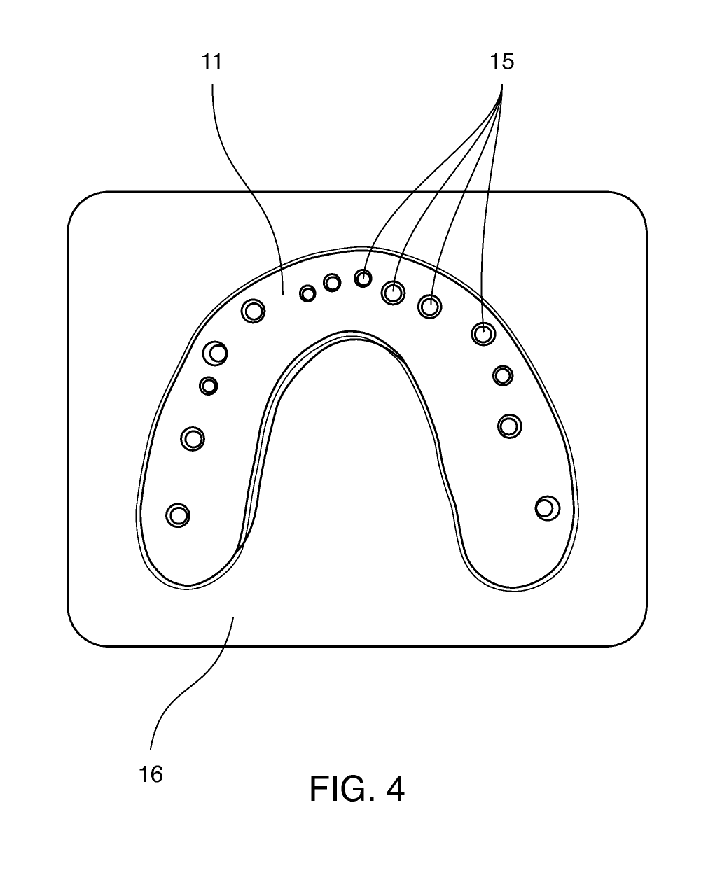

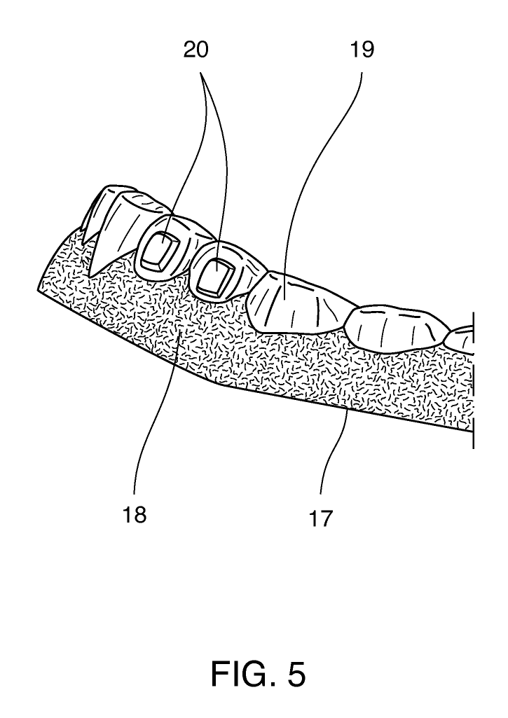

In addition to a crown 14a, the tooth models 13 also have a neck and a simplified root 14. In a departure from the very simplified shape of the roots in FIG. 1, the roots can also be made more realistic. As regards advantages of this embodiment, reference is made to the description.

The cavities 12 in said alveolar ridge model 11 are designed, in terms of their shape and/or orientation, such that they determine the orientation of the associated tooth models 13 in all six degrees of freedom.

The alveolar ridge model 11 and the tooth models 13 are produced with the aid of CAM techniques. The tooth models 13 were produced from titanium with the aid of a relatively high-resolution CNC milling method, while the alveolar ridge model 11 was produced with the aid of a relatively low-resolution 3D printing method. As regards advantages of this embodiment, reference is made to the description.

According to the invention, it is also possible, moreover, to provide several alveolar ridge models which differ from one another at least in terms of the shape and/or orientation of a cavity. As regards advantages of this embodiment, reference is made to the description.

In a departure from FIG. 1, at least one alveolar ridge model 11 can be produced from a transparent material. As regards advantages of this embodiment, reference is made to the description.

The tooth models 13 are numerically labeled in order to ensure a reproducible arrangement in the alveolar ridge model or in the different alveolar ridge models.

FIG. 2 shows a virtual model in which a virtual model of the actual state of the upper or lower jaw of the patient is combined with a virtual model of the roots of the patient's teeth. As regards advantages of this embodiment, reference is made to the description.

FIG. 3 shows tooth models which, in contrast to the tooth models shown in FIG. 1, have more realistic roots. As regards advantages of this embodiment, reference is made to the description.

FIG. 4 shows the underside of an alveolar ridge model 11 according to the present invention after the thermoforming method. The underside of the alveolar ridge model 11 has circular recesses 15, which are connected to the cavities 12. The thermoforming film 16 surrounds the alveolar ridge model with an exact fit. The inserted tooth models 13 as shown in FIG. 1 are located on the top face (not shown) of the alveolar ridge model. As regards advantages of this embodiment, reference is made to the description.

FIG. 5 shows an aligner 17 produced by the method according to the invention. The upper part 19 of the aligner 17, which was thermoformed over tooth models 13 as a negative, has a very high transparency and good surface smoothness in direct comparison with the lower part 18. Moreover, the aligner can have protuberances 20, which enclose securing elements (also called attachments) as shown in FIG. 1. The lower part 18 of the aligner 17 is thermoformed over the alveolar ridge model, which represents the gingiva, and has a lightweight structure and a greater visible roughness compared to the upper part 19. It will be seen that the aligner has anatomically shaped margins at the transition between the upper part 19 and the lower part 18; in this connection see also the description.

1-20. (canceled)

21. A method for producing an orthodontic setup, comprising the steps of:
a) producing at least one physical alveolar ridge model, said alveolar ridge model having at least one cavity adapted to receiving tooth models;
b) producing tooth models; and
c) optionally: placing the tooth models in the said alveolar ridge model.

22. The method as claimed in claim 21, wherein the tooth models have a crown and a neck.

23. The method as claimed in claim 22, wherein the tooth models further have a tooth portion.

24. The method as claimed in claim 21, wherein step a) further comprises the step of introducing at least one continuous recess into the alveolar ridge.

25. The method as claimed in claim 21, wherein the physical alveolar ridge model is a positive model of an upper or lower jaw with gingiva.

26. The method as claimed in claim 21, wherein the at least one cavity is configured to define an orientation of an associated tooth model in six degrees of freedom.

27. The method as claimed in claim 21, further comprising the step of producing a plurality of physical alveolar ridge models, each having at least one tooth cavity having a different shape or orientation from another of the plurality of physical alveolar ridge models.

28. The method as claimed in claim 21, further comprising the step of producing the physical alveolar ridge model such that it corresponds to one of an actual orthodontic state, an initial orthodontic correction state, a transitional orthodontic correction state or a final orthodontic correction state.

29. The method as claimed in claim 21, further comprising the steps of
a) producing the physical alveolar ridge model by preparing a 3D scan of a cast, which cast is obtained by taking an impression of at least a portion of the upper or lower jaw of a patient with a suitable material, or an intraoral scan of at least a portion of the upper and/or lower jaw of a patient,
b) preparing a virtual CAD model of the actual state of the upper or lower jaw of the patient, wherein, optionally, data of the 3D scans are processed to give a virtual CAD model of the actual state of the upper or lower jaw of the patient,
c) virtually removing teeth represented in the virtual CAD model of the actual state, wherein cavities corresponding to the virtually removed teeth are generated in the first alveolar ridge CAD model thus obtained, and
d) producing a physical alveolar ridge model on the basis of said first alveolar ridge CAD model by means of a CAM technique.

30. The method as claimed in claim 29, further comprising the steps of:
a) virtually manipulating an orientation of at least one tooth in the virtual CAD model of an actual orthodontic state, an initial orthodontic correction state or a transitional orthodontic correction state, such that after such virtual manipulation, the resulting orientation of the at least one cavity associated with the at least one tooth is altered in the modified alveolar ridge CAD model thereby obtained, and
b) producing a physical modified alveolar ridge model on the basis of the modified alveolar ridge CAD model by a CAM technique.

31. The method as claimed in claim 29, further comprising the steps of:
a) virtually manipulating at least an orientation or shape of at least one cavity in an alveolar ridge CAD model, wherein an orientation of a tooth model associated with the at least one cavity is altered thereby producing a modified alveolar ridge CAD model; and
b) producing a physical modified alveolar ridge model on the basis of the modified alveolar ridge CAD model by a CAM technique.

32. The method as claimed in claim 29, further comprising the steps of generating a CAD model of at least one tooth root by an imaging method and adding the at least one tooth root CAD model to the virtual CAD model of the actual state of the upper or lower jaw of the patient.

33. The method as claimed in claim 29, wherein the step of virtually removing teeth is followed by the step of generating, revising and storing at least one tooth CAD model of the removed tooth.

34. The method as claimed in claim 33, further comprising the step of producing at least one physical model of a tooth on the basis of the tooth CAD model by means of a CAM technique.

35. The method as claimed in claim 34, wherein the CAM technique used for producing the physical model of a tooth has a higher resolution than the CAM technique used for producing the physical alveolar ridge model.

36. The method as claimed in claim 21, wherein the at least one alveolar ridge model is produced from a transparent material.

37. The method as claimed in claim 21, wherein the at least one cavity engages the at least one tooth model with an exact fit.

38. An orthodontic setup, or a kit comprising several orthodontic setups each produced by the method of claim 21.

39. A method for producing at least one orthodontic aligner, comprising the step of thermoforming a suitable material on an orthodontic setup as claimed in claim 21.

40. The method as claimed in claim 39, wherein the produced orthodontic aligner has a greater roughness in an area of the alveolar ridge model than in a part of the orthodontic aligner formed over crowns.

41. An aligner or a set of aligners, produced by the method of claim 29.
